(19) United States
(12) Patent Application Publication
(10) Pub. No.: US 2021/0367275 A1
(43) Pub. Date: Nov. 25, 2021

(54) METAL-ACID-HYDROGEN ENERGY BATTERY

(71) Applicant: SHEN ZHOU, Ningbo (CN)

(72) Inventor: SHEN ZHOU, Ningbo (CN)

(21) Appl. No.: 17/396,753

(22) Filed: Aug. 8, 2021

(51) Int. Cl. H01M 10/36; H01M 10/44; H01M 8/0656; H01M 10/42

(52) U.S. Cl. CPC H01M 10/36; H01M 10/44; H01M 2300/0028; H01M 10/425; H01M 8/0656

(57) ABSTRACT

The present invention provides a metal-acid-hydrogen energy battery which comprises an electrolyte chamber and an acid storage container, wherein an electrolyte port and a hydrogen collection port are formed in the electrolyte chamber, a metal anode and a cathode are oppositely inserted into the electrolyte chamber, the electrolyte chamber communicates with the acid storage container through an acid adding pipeline, and a valve is formed in the acid adding pipeline. The metal-acid-hydrogen energy battery has a wide application range and can be used as a power supply of transportation tools such as airplanes, automobiles, electric motorcycles, various unmanned aerial vehicles, ships and submarines.

### TECHNICAL FIELD

The present invention relates to the technical field of batteries, in particular to a metal-acid-hydrogen energy battery.

### BACKGROUND

A battery is a device containing an electrolyte solution and metal electrodes to produce a current and can convert chemical energy to electrical energy. In a chemical battery, direct conversion of the chemical energy to the electrical energy is a result of chemical reactions, such as redox, spontaneously conducting inside the battery, and such reactions is conducted on two electrodes separately. Andoe active materials are usually composed of reducing agents that have a relatively negative potential and are stable in the electrolyte, such as zinc, cadmium, lead and other active metals and hydrogen or hydrocarbons. Cathode active materials are mainly composed of oxidisers that have a relatively positive potential and are stable in the electrolyte, such as manganese dioxide, lead dioxide, nickel oxide and other metal oxides, oxygen or air, halogens and salts thereof, oxyacids and salts thereof. The electrolytes are usually materials with good ionic conductivity, such as aqueous solutions of acids, bases and salts, organic or inorganic non-aqueous solutions, molten salts or solid electrolytes.

Chemical batteries may be divided into primary batteries (primary batteries), secondary batteries (rechargeable batteries), lead-acid batteries and fuel batteries according to working properties, wherein the secondary batteries may be divided into nickel-cadmium batteries, nickel-hydrogen batteries, lithium-ion batteries, secondary alkaline zinc-manganese batteries and the like. The lithium-ion batteries mainly rely on lithium ions moving between positive and andoes to work, while hydrogen fuel batteries generate power by mainly using direct conversion of the chemical energy of hydrogen and oxygen to the electric energy. However, existing rechargeable lithium batteries have some defects, such as low energy density, large mass, short life, expensive anode and cathode materials and the like, and utilization of hydrogen energy has the problems of difficulty in transportation and storage and the like.

In view of these, the present invention is proposed.

### SUMMARY

An objective of the present invention is to provide a metal-acid-hydrogen energy battery which can both provide electric energy and generate hydrogen, so that the technical problems of hydrogen generation, storage and transportation in hydrogen energy utilization and the like are solved, the overall energy density of a battery is greatly increased, a selection range of andoe materials and cathode materials of the battery is expanded, the cost of a battery electrode is lowered, and the service life of a rechargeable battery is prolonged.

In order to solve the above-mentioned technical problems, the present invention specifically adopts the following technical solution:

The present invention provides the metal-acid-hydrogen energy battery which comprises an electrolyte chamber and an acid storage container, wherein an electrolyte port and a hydrogen collection port are formed in the electrolyte chamber, a metal anode and a cathode are oppositely inserted into the electrolyte chamber, the electrolyte chamber communicates with the acid storage container through an acid adding pipeline, a valve is formed in the acid adding pipeline, a hydrogen ion inlet is formed in the acid storage container, the electrolyte chamber and the acid storage container further communicate with each other through a charging pipeline, and valves are respectively formed in the hydrogen ion inlet and the charging pipeline.

Further, a spacer is disposed in the electrolyte chamber, comprises a valve and divides the electrolyte chamber into a first working area and a second working area, the metal anode and the cathode are respectively located in the first working area and the second working area, the first working area and the second working area communicate with each other through the valve in the spacer, and hydrogen collection ports are respectively formed in the first working area and the second working area.

Further, the hydrogen collection ports communicate with a hydrogen inlet of a hydrogen fuel battery or a fuel inlet of an internal combustion engine directly or through a low-pressure gas storage tank.

Further, the metal-acid-hydrogen energy battery of the present invention further comprises controls electrically connected with various valve to control the valves respectively.

Further, valves are respectively formed in a hydrogen output pipeline and an electrolyte input pipeline, and the controls are electrically connected with the valves on the hydrogen output pipeline and the electrolyte input pipeline to control the valves respectively.

Further, the metal anode is a lithium anode, a potassium anode, a sodium anode, a calcium anode, a magnesium anode, an aluminum anode, a beryllium anode, a titanium anode, a manganese anode, a zinc anode, an iron anode, a nickel anode or an alloy anode.

Further, the cathode is a graphite cathode, a copper cathode, a silver cathode, a gold cathode or a platinum cathode.

Further, an acid solution is stored in the acid storage container, is inorganic acid and/or organic acid and is selected from one or more mixtures of carbonic acid, hydrochloric acid, sulfuric acid, phosphoric acid, nitric acid, hydrobromic acid, formic acid and acetic acid.

Further, an electrolyte is stored in the electrolyte chamber and is a solution of water and soluble salt or a solution of an ionic liquid and soluble salt.

Compared with the prior art, the present invention has the following beneficial effects:

1. By arranging the metal anode, the cathode and the acid storage container, the metal-acid-hydrogen energy battery of the present invention can generate hydrogen while providing electricity, so that the technical problems such as production, storage and transportation of the hydrogen in hydrogen energy utilization are solved, and the overall specific energy of the battery is increased.

2. By controlling an acid concentration of the electrolyte and an amount of the electrolyte in the electrolyte chamber, the metal-acid-hydrogen energy battery of the present invention may control the discharge rate and the hydrogen production rate and the produced hydrogen can be conveyed to a hydrogen fuel battery directly or through a low-pressure gas storage tank to further generate electric energy or the hydrogen can be used as a fuel of the internal combustion engine to directly generate power.

3. The metal-acid-hydrogen energy battery of the present invention can utilize the chemical energy and the hydrogen energy to generate electricity at the same time, so that the overall energy density of the battery is greatly increased; and in addition, the acid solution reacts with the metal anode, which expands the selection range of the andoe materials and the cathode materials of the battery, reduces the cost of the battery electrode and prolongs the life of the rechargeable battery.

4. The metal-acid-hydrogen energy battery of the present invention may be used as both a primary battery and a rechargeable battery, has a wide application range and may be used as a power supply of transportation tools such as airplanes, automobiles, electric motorcycles, various unmanned aerial vehicles, ships and submarines.

### BRIEF DESCRIPTION OF THE DRAWINGS

In order to more clearly explain the detailed description of the present invention or the technical solution in the prior art, the drawings required for use in the description of the detailed description or prior art will be briefly described below, and it will be apparent that the drawings in the following description are some embodiments of the present invention from which other drawings can be obtained without creative effort by those of ordinary skill in the art.

FIG. 1 is a structural schematic diagram of a metal-acid-hydrogen energy battery of the present invention during discharge process;

FIG. 2 is a structural schematic diagram of a metal-acid-hydrogen energy battery of the present invention during charging process.

FIG. 3 is a structural schematic diagram of a metal-acid-hydrogen energy battery provided with a spacer of the present invention during discharge process;

FIG. 4 is a structural schematic diagram of a metal-acid-hydrogen energy battery provided with a spacer of the present invention during charging process.

### DESCRIPTION OF REFERENCE NUMBERS

1: electrolyte chamber 2. acid storage container; 3. electrolyte port; 4. hydrogen collection port; 5. metal anode; 6: cathode; 7: hydrogen ion inlet; 8: acid adding pipeline; 9: charging pipeline; 10: external power supply; 11: spacer; 12: first working area; 13: second working area; 14: acid solution; 15: electrolyte.

### DETAILED DESCRIPTION

It should be noted that the following detailed description is illustrative and is intended to provide further explanation of this application. Unless otherwise indicated, all technical and scientific terms used herein have the same meanings as those of ordinary skill in the art to which this application pertains.

It should be noted that the terminology used herein is intended to describe the detailed description only and is not intended to limit exemplary embodiments according to this application. As used herein, the singular form comprises the plural form unless the context expressly dictates otherwise. In addition, it should also be understood that when used in this description, the terms “including” and/or “comprising” indicate the presence of features, steps, operations, devices, components and/or combinations thereof.

Hereinafter, the technical solution of the present invention will be clearly and completely described in combination with embodiments. Obviously, the described embodiments are only a part of the embodiments of the present invention and not all embodiments. Based on the embodiments of the present invention, other embodiments obtained by those of ordinary skill in the art without involving any inventive effort are within the scope of the present invention.

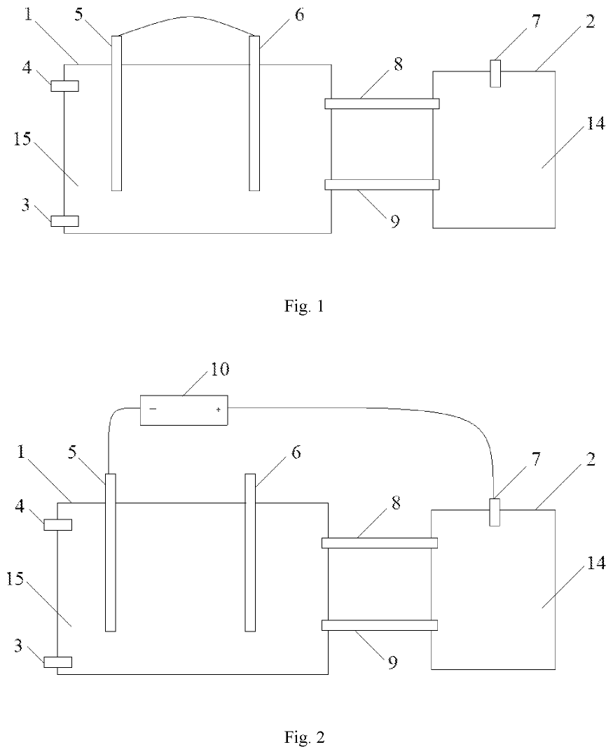

As shown in FIG. 1 and FIG. 2, the metal-acid-hydrogen energy battery of this embodiment comprises an electrolyte chamber 1 and an acid storage container 2, wherein an electrolyte port 3 and a hydrogen collection port 4 are formed in the electrolyte chamber 1, a metal anode 5 and a cathode 6 are oppositely inserted into the electrolyte chamber 1, the electrolyte chamber 1 communicates with the acid storage container 2 through an acid adding pipeline 8, a valve is formed in the acid adding pipeline (not shown). The metal-acid-hydrogen energy battery with this structure may be used as a primary battery.

Furthermore, a hydrogen ion inlet 7 is formed in the acid storage container 2, the electrolyte chamber 1 further communicates with the acid storage container 2 through a charging pipeline 9, and valves (not shown) are respectively formed in the hydrogen ion inlet 7 and the charging pipeline 9. The metal-acid-hydrogen energy battery with this structure may be used as a rechargeable battery.

In the above-mentioned metal-acid-hydrogen energy battery, the acid storage container 2 is mainly used for storing an acid solution 14 and supplying the acid solution 14 to the electrolyte chamber 1, and the structure of the acid storage container 2 is not strictly limited, and a conventional acid storage container in the art may be adopted. Specifically, the acid storage container 2 may have a hydrogen ion inlet 7 through which hydrogen ions produced during hydrolysis of an external power supply 10 in the charging process may enter the acid storage container 2. The acid solution 14 is stored in the acid storage container 2, is not strictly limited and may be conventional inorganic acid and/or organic acid in the art. Specifically, the acid solution 14 may be selected from one or more mixtures of carbonic acid, hydrochloric acid, sulfuric acid, phosphoric acid, nitric acid, hydrobromic acid, formic acid and acetic acid. Since a concentration of the acid solution in the electrolyte chamber 1 may decrease during continuous discharge, the acid solution stored in the acid storage container 2 may be high-concentration acid. In order to maintain continuous discharge reaction, the high-concentration acid in the acid storage container 2 may be added in the electrolyte chamber 1 through the acid adding pipeline 8, so that the constant concentration of the acid in the electrolyte 15 is maintained. It can be understood that the high concentration acid is diluted after entering the electrolyte chamber 1, so that the acid in the electrolyte 15 is low concentration acid, which is relatively mild when reacting with the metal anode 5, and the safety of the battery is ensured.

The electrolyte chamber 1 is mainly used for containing the electrolyte 15, the metal anode 5 and the cathode 6 to convert chemical energy to electrical energy to produce an electric current, and the structure of the electrolyte chamber 1 is not strictly limited, and a conventional structure in the art can be adopted. The metal anode 5 and the cathode 6 are oppositely inserted into the electrolyte chamber 1, wherein the metal anode 5 may be a lithium anode, a potassium anode, a sodium anode, a calcium anode, a magnesium anode, an aluminum anode, a beryllium anode, a titanium anode, a manganese anode, a zinc anode, an iron anode, a nickel anode, an alloy anode, etc., and the cathode 6 may be a graphite cathode, a copper cathode, a silver cathode, a gold cathode, a platinum cathode, etc. Furthermore, the electrolyte 15 is stored in the electrolyte chamber 1 and is not strictly limited, and a conventional electrolyte in the art, such as a solution of water and soluble salt or a solution of an ionic liquid and soluble salt, may be adopted.

An electrolyte port 3 is formed in the electrolyte chamber 1, is mainly used for the electrolyte 15 to enter the electrolyte chamber 1 and may be formed in the lower part of the electrolyte chamber 1. When discharge is required, the electrolyte 15 may be injected into the electrolyte chamber 1 from the electrolyte port 3, and hydrogen will be produced by the cathode 6. When discharge is stopped, a pipeline for conveying the electrolyte 15 may be drawn out of the electrolyte chamber 1, or the metal anode 5 may be removed from the electrolyte chamber 1, and at this time, the discharge is stopped.

Furthermore, a hydrogen collection port 4 is further formed in the electrolyte chamber 1, is mainly used for collecting hydrogen and may be formed in the upper part of the electrolyte chamber 1. Further, the metal-acid-hydrogen energy battery may also comprise a low-pressure gas storage tank (not shown) which is mainly used for low-pressure storage of hydrogen, and at this time, the inlet end of the low-pressure gas storage tank may communicate with the hydrogen collection port 4. The hydrogen collection port 4 may communicate with a hydrogen inlet of a hydrogen fuel battery or a fuel inlet of an internal combustion engine directly or through the low-pressure gas storage tank, so that utilization of the produced hydrogen is facilitated. The above-mentioned method can well solve the technical problems such as hydrogen storage and transportation in hydrogen energy utilization.

In the metal-acid-hydrogen energy battery of the present invention, the discharge rate and the hydrogen production rate may be controlled by controlling an acid concentration in the electrolyte and an amount of the electrolyte in the electrolyte chamber of the battery.

For convenience in control on operation of the metal-acid-hydrogen energy battery, controls (not shown) may further be disposed and may be electrically connected with various valves to control the valves respectively. Specifically, when it is necessary to convey hydrogen ions into the acid storage container 2, the valve formed in the hydrogen ion inlet 7 may be controlled to open by the corresponding control, so that conveying of hydrogen ions into the acid storage container 2 is facilitated. When it is necessary to add acid from the acid storage container 2 to the electrolyte chamber 1, the valve formed in the acid adding pipeline 8 may be controlled by the corresponding control to adjust an acid adding amount, and thus the rates of hydrogen production and discharging during battery reaction are adjusted. During charging, the valves formed in the charging pipeline 9 and the hydrogen ion inlet 7 respectively may be controlled to open by the corresponding controls, anions originally paired with metal ions in the electrolyte 15 enter the acid storage container 2 through the charging pipeline 9, hydrogen ions produced by hydrolysis of the external power supply 10 enter the acid storage container 2 through the hydrogen ion inlet 7 and are combined with anions entering the acid storage container 2 from the charging pipeline 9 at the same time, and a valve formed in the charging pipeline 9 is controlled when charging is completed.

Furthermore, valves may further be formed in the hydrogen output pipeline and the electrolyte input pipeline respectively, and the controls may be electrically connected with the valves formed in the hydrogen output pipeline and the electrolyte input pipeline respectively to control the valves. It can be understood that the hydrogen output pipeline is a pipeline for supplying hydrogen to the hydrogen fuel battery or the internal combustion engine, and the electrolyte input pipeline is a pipeline for conveying the electrolyte 15 to the electrolyte chamber 1 and communicates with the electrolyte port 3. When it is necessary to end discharge, the valve formed in the electrolyte input pipeline may be controlled to close by the corresponding control, and discharge reaction is terminated at this time. Furthermore, when it is necessary to utilize the hydrogen, the valve formed in the hydrogen output pipeline may be controlled to open by the corresponding control, and hydrogen can be supplied to the hydrogen fuel battery or the internal combustion engine at this time.

As shown in FIG. 1, the discharge process of the metal-acid-hydrogen energy battery of this embodiment is as follows:

The electrolyte 15 enters the electrolyte chamber 1 of the battery through the electrolyte port 3; at the same time, the acid solution 14 enters the battery through the acid storage container 2 and the acid adding pipeline 8. In the electrolyte chamber 1, the metal anode 5 reacts with the acid solution to produce the hydrogen, and the metal in the anode loses electrons and becomes metal ions to enter the electrolyte 15. The electrons flow from the metal anode 5 to the cathode 6 and are combined with hydrogen ions in the electrolyte 15 to produce the hydrogen. The anions originally paired with the acid 14 are combined with newly formed metal cations, and the current produced in this process may be used to drive an electrical appliance. Meanwhile, the produced hydrogen is collected and conveyed to the low-pressure gas storage tank at the hydrogen collection port 4, and may be used as a fuel hydrogen fuel battery to generate electric energy or the hydrogen produced be used as the fuel of the internal combustion engine to directly generate power. If continuous discharge is needed, the acid solution 14 may be continuously added in the electrolyte chamber 1 from the acid storage container 2, and the amount of acid added can be controlled by the corresponding control to adjust the rates of hydrogen production and discharge of battery reaction. If it is necessary to end discharge, the electrolyte inlet pipeline may be drawn out of the electrolyte port 3, the metal anode 5 may be removed from the electrolyte chamber 1, or the valve formed in the electrolyte inlet pipeline may be controlled to close by the corresponding control, and battery discharge reaction is terminated at this time.

As shown in FIG. 2, the charging process of the metal-acid-hydrogen energy battery of this embodiment is as follows:

the electrolyte 15 enters the electrolyte chamber 1 of the battery through the electrolyte port 3, the anode is connected to an andoe of the external power supply 10, a cathode of the external power supply 10 is located in an aqueous electrolyte of the external power supply 10, and the electrolyte of the external power supply 10 is connected with the hydrogen ion inlet 7 through a pipeline to control opening of a valve formed in the hydrogen ion inlet 7. During charging, the valve formed in the acid adding pipeline 8 is controlled to close, and the valve formed in the charging pipeline 9 is controlled to open. The cathode of the external power supply 10 electrolyzes water molecules to produce oxygen and hydrogen ions, the cathode obtains electrons from the water molecules and conveys the electrons to the andoe of the external power supply 10, and then the electrons enter the metal anode 5 of the battery from the andoe to be combined with the metal ions of the electrolyte 15 in the battery to form metal atoms. Anions originally paired with the metal ions in the battery electrolyte 15 enter the acid storage container 2 through the charging pipeline 9. Meanwhile, the hydrogen ions produced during hydrolysis of the external power supply 10 enter the acid storage container 2 through the hydrogen ion inlet 7 and are combined with anions entering the acid storage container 2 from the charging pipeline 9. When charging is completed, the valve formed in the control charging pipeline 9 and the valve formed in the hydrogen ion inlet 7 are controlled to close and are disconnected with the electrolyte pipe of the external power supply 10.

When magnesium metal is used as anode material (that is, a magnesium anode is employed), a dilute hydrochloric acid solution is used as the electrolyte 15, and graphite is used as cathode material (that is, a graphite cathode is employed), the measured voltage is 1.8V and the discharge current density reaches 30 mA per square centimeter. 2 grams of hydrogen is produced by using 24 grams of magnesium metal and 73 grams of hydrochloric acid, and 60 wh of electric energy is actually measured. According to the above-mentioned actually measured data, the specific energy of the battery is about 0.6 kWh/kg, and the total specific energy exceeds 1 kWh/kg after the electric energy generated by the produced hydrogen is taken into account. Based on the above-mentioned experimental data, the specific energy of a metal-acid-hydrogen energy battery product may approach 1.5 kWh/kg.

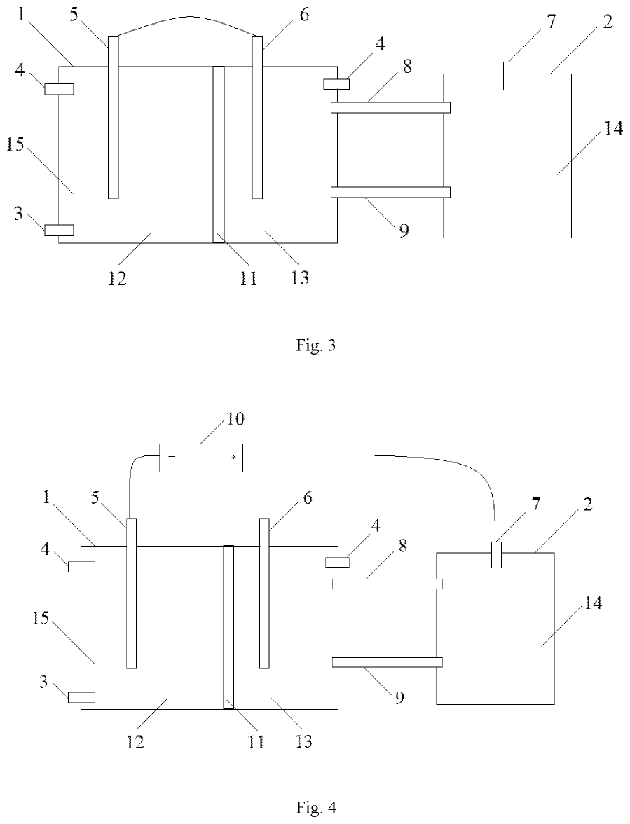

Further, in order to protect the metal anode 5, the loss of the metal anode 5 is avoided. As shown in FIG. 3 and FIG. 4, in the metal-acid-hydrogen energy battery of this embodiment, a spacer 11 is further disposed in the electrolyte chamber 1, comprises a valve (not shown) and divides the electrolyte chamber 1 into a first working area 12 and a second working area 13, the metal anode 5 and the cathode 6 are respectively located in the first working area 12 and the second working area 13, the first working area 12 and the second working area 13 communicate with each other through the valve in the spacer 11, and hydrogen collection ports are respectively formed in the first working area 12 and the second working area 13. Furthermore, the valve in the spacer 11 may be electrically connected to the corresponding control to control the valve.

Further, in order to enable anions originally paired with the metal ions in the battery electrolyte 15 to enter the second working area 13 through the spacer 11, the spacer 11 is further provided with an anion membrane; and in order to enable the negative ions to pass through the charging pipeline 9, an anion membrane is disposed in a flow passage of the charging pipeline 9.

When a discharge state is applied, as shown in FIG. 3, the discharge process of the metal-acid-hydrogen energy battery is as follows:

The electrolyte 15 enters the first working area 12 of the electrolyte chamber 1 through the electrolyte port 3, the valve in the spacer 11 is controlled to open, and the metal anode 5 loses electrons and enters the electrolyte 15 as metal cations. Electrons flow from the metal anode 5 to the cathode 6 and are combined with hydrogen ions in the second working area 13 to produce hydrogen. Anions originally paired with hydrogen ions enter the first working area 12 through the anion membrane of the spacer 11 to be combined with newly produced metal ions. In the discharge process, a small amount of hydrogen ions diffuses to the first working area 12 and react with the metal anode 5 to produce hydrogen. The hydrogen produced in the discharge process is discharged out of the battery through the hydrogen collection ports 4 of the first working area 12 and the second working area 13 separately, and a current generated by the battery in this process may be used to drive the electrical appliance. Meanwhile, the produced hydrogen is collected and conveyed to the low-pressure gas storage tank at the hydrogen collection port 4, and may be used as a fuel to generate electric energy in a hydrogen fuel battery or directly generate power by using hydrogen as a fuel of an internal combustion engine. If continuous discharge is needed, the valve formed in a hydrogenation pipeline may be controlled to open, so that the acid solution 14 in the acid storage container 2 is continuously added in the second working area 13, and the acid adding amount may be adjusted by controlling the valve at the same time, so that the rates of hydrogen production and discharge of the battery reaction are adjusted. If it is necessary to end discharge, the electrolyte inlet pipeline may be drawn out of the electrolyte port 3, the metal anode 5 may be removed from the first working area 12, or the valve formed the electrolyte inlet pipeline may be controlled to close by the corresponding control, and battery discharge reaction is terminated at this time.

When the charging state is applied, as shown in FIG. 4, the charging process of the metal-acid-hydrogen energy battery is as follows:

the electrolyte 15 enters the first working area 12 through the electrolyte port 3, the anode is connected to the andoe of the external power supply 10, the cathode of the external power supply 10 is located in the aqueous electrolyte of the external power supply 10, and the electrolyte of the external power supply 10 is connected with the hydrogen ion inlet 7 through a pipeline to control opening of the valve formed in the hydrogen ion inlet 7. During charging, the valve formed in the acid adding pipeline 8 is controlled to be closed, and the valve formed in the charging pipeline 9 is opened at the same time. The cathode of the external power supply 10 electrolyzes water molecules to produce oxygen and hydrogen ions, the cathode obtains electrons from the water molecules and conveys the electrons to the andoe of the external power supply 10, and then the electrons enter the metal anode 5 of the battery from the andoe of the power supply to be combined with the electrolyte metal ions in the first working area 12 to form metal atoms. The anions originally paired with metal ions in the battery electrolyte 15 enter the second working area 13 through the anion membrane and the valve of the spacer 11, and the anions enter the acid storage container 2 from the charging pipeline 9. Meanwhile, the hydrogen ions produced during hydrolysis of the external power supply 10 enter the acid storage container 2 through the hydrogen ion inlet 7 and are combined with anions entering the acid storage container 2 from the charging pipeline 9. When charging is completed, the valve formed in the charging pipeline 9 is controlled to be closed, the valve formed in the hydrogen ion inlet 7 is closed at the same time to be disconnected with the electrolyte pipe of the external power supply 10.

The above-mentioned metal-acid-hydrogen energy battery is provided with an acid storage container 2, wherein the acid solution 14 stored in the acid storage container 2 communicates with the electrolyte chamber 1 through the acid adding pipeline 8 and can react with the metal anode 5 to produce the hydrogen, and the metal anode 5 loses electrons and becomes metal ions to enter the electrolyte 15. The electrons flow from the metal anode 5 to the cathode 6 and are combined with hydrogen ions in the electrolyte 15 to produce the hydrogen. The anions originally paired with the acid solution 14 are combined with the newly produced metal cations, and the current generated in this process can be used to drive the electrical appliance. Meanwhile, the produced hydrogen is collected and conveyed to the low-pressure gas storage tank at the hydrogen collection port 4 and may be used as a fuel of the hydrogen fuel battery to generate electric energy or the hydrogen may be used as the fuel of the internal combustion engine to directly generate power. The above-mentioned metal-acid-hydrogen energy battery both provides the electric energy and produces the hydrogen, so that the technical problems of hydrogen generation, storage and transportation and the like in hydrogen energy utilization are solved. Since power can be generated by using the chemical energy and the hydrogen energy at the same time the overall energy density of the battery is greatly increased. By providing the spacer 11, the metal anode 5 is well protected, and the loss of the metal anode 5 is avoided. Furthermore, the acid solution 14 is used to react with the metal anode 5, the selection range of andoe materials and cathode materials of the battery are expanded, the cost of a battery electrode is lowered, and the service life of a rechargeable battery is prolonged. The above-mentioned metal-acid-hydrogen energy battery has a wide application range and may be used as a power supply of transportation tools such as airplanes, automobiles, electric motorcycles, various unmanned aerial vehicles, ships and submarines.

The present invention has the following characteristics:

1. The metal-acid-hydrogen energy battery of the present invention can produce the hydrogen while providing electricity by arranging the metal anode, the cathode and the acid storage container, so that the technical problems such as production, storage and transportation of hydrogen and the like in hydrogen energy utilization are solved, and the overall specific energy of the battery is improved.

2. The metal-acid-hydrogen energy battery of the present invention may control the discharge rate and the hydrogen production rate by controlling the acid concentration of the electrolyte and the amount of the electrolyte in the electrolyte chamber, and the produced hydrogen can be conveyed to a hydrogen fuel battery directly or through a low-pressure gas storage tank to further generate electric energy, or the hydrogen can be used as the fuel of the internal combustion engine to directly generate power.

3. The metal-acid-hydrogen energy battery of the present invention can utilize chemical energy and hydrogen energy to generate electricity at the same time, and thus the overall energy density of the battery is greatly increased; and in addition, the acid solution reacts with the metal anode, so that the selection range of the andoe materials and the cathode materials of the battery are expanded, the cost of the battery electrode is lowered, and the life of the rechargeable battery is prolonged.

4. The metal-acid-hydrogen energy battery of the present invention may be used as both a primary battery and a rechargeable battery, has a wide application range and may be used as a power supply of transportation tools such as the airplanes, the automobiles, the electric motorcycles, the various unmanned aerial vehicles, the ships and the submarines.

Finally, it should be illustrated that the above-mentioned embodiments are only used to illustrate the technical solution of the present invention and shall not be construed as limitation. Although the present invention has been described in detail with reference to the foregoing embodiments, it should be understood by those of ordinary skill in the art that the technical solution described in the foregoing embodiments can still be modified or some or all of the technical features thereof can be equivalently replaced; while these modifications or replacements will not make the essential of corresponding technical solution depart from the scope of the technical solution of the embodiments of the present invention.

1. A metal-acid-hydrogen energy battery, characterized by comprising an electrolyte chamber and an acid storage container, wherein an electrolyte port and a hydrogen collection port are formed in the electrolyte chamber, a metal anode and a cathode are oppositely inserted into the electrolyte chamber, the electrolyte chamber communicates with the acid storage container through an acid adding pipeline, a valve is formed in the acid adding pipeline, a hydrogen ion inlet is formed in the acid storage container, the electrolyte chamber and the acid storage container further communicate with each other through a charging pipeline, and valves are respectively formed in the hydrogen ion inlet and the charging pipeline.

2. The metal-acid-hydrogen energy battery according to claim 1, wherein a spacer is disposed in the electrolyte chamber, comprises a valve and divides the electrolyte chamber into a first working area and a second working area, the metal anode and the cathode are respectively located in the first working area and the second working area, the first working area and the second working area communicate with each other through the valve in the spacer, and hydrogen collection ports are respectively formed in the first working area and the second working area.

3. The metal-acid-hydrogen energy battery according to claim 1, wherein the hydrogen collection ports communicate with a hydrogen inlet of a hydrogen fuel battery or a fuel inlet of an internal combustion engine directly or through a low-pressure gas storage tank.

4. The metal-acid-hydrogen energy battery according to claim 1, wherein further comprising controls electrically connected with various valves to control the valves respectively.

5. The metal-acid-hydrogen energy battery according to claim 4, wherein valves are respectively formed in a hydrogen output pipeline and an electrolyte input pipeline, and the controls are electrically connected with the valves formed in the hydrogen output pipeline and the electrolyte input pipeline to control the valves respectively.

6. The metal-acid-hydrogen energy battery according to claim 1, wherein the metal anode is a lithium anode, a potassium anode, a sodium anode, a calcium anode, a magnesium anode, an aluminum anode, a beryllium anode, a titanium anode, a manganese anode, a zinc anode, an iron anode, a nickel anode or an alloy anode.

7. The metal-acid-hydrogen energy battery according to claim 1, wherein the cathode is a graphite cathode, a copper cathode, a silver cathode, a gold cathode or a platinum cathode.

8. The metal-acid-hydrogen energy battery according to claim 1, wherein an acid solution is stored in the acid storage container, is inorganic acid and/or organic acid and is selected from one or more mixtures of carbonic acid, hydrochloric acid, sulfuric acid, phosphoric acid, nitric acid, hydrobromic acid, formic acid and acetic acid.

9. The metal-acid-hydrogen energy battery according to claim 1, wherein an electrolyte is stored in the electrolyte chamber and is a solution of water and soluble salt or a solution of an ionic liquid and soluble salt.
